(19) United States
(12) Patent Application Publication
(10) Pub. No.: US 2014/0344235 A1
(43) Pub. Date: Nov. 20, 2014

(54) DETERMINATION OF DATA MODIFICATION

(71) Applicants: EMMANUEL ZARPAS, Paris (FR); Sebastien Ducaule, Levallois Perret (FR)

(72) Inventors: EMMANUEL ZARPAS, Paris (FR); Sebastien Ducaule, Levallois Perret (FR)

(21) Appl. No.: 13/896,335

(22) Filed: May 17, 2013

(51) Int. Cl. G06F 17/30

(52) U.S. Cl. CPC G06F 17/30336
USPC 707/696

(57) ABSTRACT

To determine a row with modified data, a dataset is retrieved from a data store and displayed on a user interface in rows and columns. A first database index corresponding to the rows is generated and stored in a technical column in the data store. An input is received on the UI to modify the displayed dataset and the modified dataset is stored in the data store. A second database index corresponding to the rows including modified dataset is generated and the associated field of the technical column in the data store is updated with the second database index. The row including the modified dataset is determined based on the second database index stored in the technical column.

### BACKGROUND

The amount of data in an enterprise presents challenges. Indeed for some enterprises the amount of data grows in volume at an exponential rate. Such data may reside in a data store in different file formats. This data may include business information related to revenue, sales, operational data, or the like, associated with the enterprise. For instance, the sales data includes sales information represented by different attributes and associated values. Some attributes and values may be identical. Conventional data processing systems access and retrieve the data from the data store, analyze the attribute and values, generate results based on the analysis and display it on a user interface. However, the conventional data processing systems may not provide a mechanism to modify the attribute values in real time via a user interface. The conventional data processing systems do not provide a mechanism to determine the modified values. Hence, identifying the modified attributes and values in a large volume of data becomes challenging.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating determination of a row with modified dataset, according to an embodiment.

FIG. 2 is a flow diagram illustrating a method to determine a row with modified dataset, according to an embodiment.

FIG. 3 is an exemplary illustration of an overview of a system to determine a row with modified dataset, according to an embodiment,

FIG. 4A is an exemplary illustration of dataset residing in a table in a data store, according to an embodiment.

FIG. 4B is an exemplary illustration of dataset displayed on a second user interface of the business intelligence system, according to an embodiment.

FIG. 5A is an exemplary illustration of dataset residing in a table in a data store, according to an embodiment.

FIG. 5B is an exemplary illustration of dataset displayed on a second user interface of the business intelligence system, according to an embodiment.

FIG. 6 is a block diagram of an exemplary computer system according (to one embodiment.

### DETAILED DESCRIPTION

Embodiments of techniques for determination of data modification are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Volume of business data associated with an enterprise has evidenced an exponential growth as a function of time. The business data may be represented as datasets having data fields and may reside in a data store in different file formats. To sustain growing business demands, enterprises may need systems including applications that transmute this data into meaningful information. These applications transmute the data by processing the data, analyzing, and structuring the data to convey useful information. These applications may be configured to implement business intelligence techniques, advanced data processing techniques, and mathematical models. Further, the applications may provide design and runtime tools for generating charts from the data, and the like, to analyze and structure the data into useful information.

The applications herein referred to as business intelligence (BI) applications or a BI application may be developed using different technologies and may be deployed on diverse platforms or frameworks. The BI application may provide a collaborative platform for sharing data, managing and sharing knowledge and information and regulating flow of the data including information across the enterprise. The BI application may be operable to connect to operational data store and interpret associated data definitions. Based on the associated data definitions, the BI application may be able to identify the association of data—with diverse processes of the enterprise. In an embodiment, the BI application transmutes the data into useful information, to provide assistance in making important business decisions. The BI application hence provides a standalone consistent solution to process, analyze and structure the data to provide fact based support systems for the enterprises.

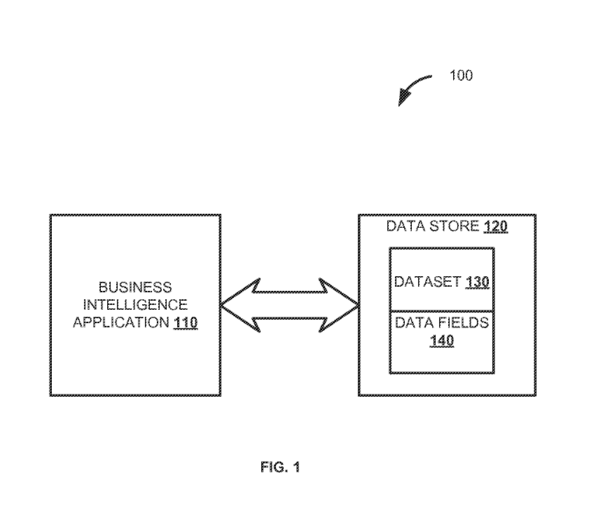

FIG. 1 is a block diagram illustrating determination of a row with modified dataset, according to an embodiment. In an embodiment, the block diagram 100 includes a data store 120 that may be a conventional database, an in-memory database, a web based data store, operational data store, distributed data store, or the like. The data store 120 contains data represented as datasets 130. Each dataset 130 may have data fields 140 of various data types. The dataset 130 includes business information, for example data related to revenue, sales, operational data, or the like, associated with an enterprise. Data fields may represent attributes and values associated with the data related to revenue, sales, and the like.

In an embodiment, an application, for example a BI application 110, is communicatively coupled to the data store 120. The BI application 110 includes multiple interfaces that provide a diverse set of functionalities. The set of functionalities may include selecting the dataset from the data store 120; filtering the dataset to generate consistent data format; sorting the dataset per a user's preference; displaying the selected datasets retrieved from data store 120; providing tools and models to process, analyze and structure the dataset in a user defined format; generating and rendering visualizations based on the analysis and structuring of the dataset, and the like.

In an embodiment, based on the selected dataset 130 from the data store 120, the BI application 110 retrieves dataset 130 including the data fields 140, and displays the dataset 130 on a user interface UI) in multiple cells arranged as rows and columns. The data fields 140 include attributes, represented by the columns and associated values represented by the rows. A function, for example a hash function, is associated with the rows of the dataset 130. Based on the hash function, the BI application 110 generates database indices, for example a first database index corresponding to each row and stores the first indices in a column, for example, a technical column, associated with the dataset. The technical column including the first indices is stored in the data store 120, in another embodiment, the BI application 110 may generate database indices based on an algorithm for example, a hash algorithm associated with the rows of the dataset 130.

In an embodiment, the UI is operable to receive an input from a user in real time to modify or manipulate the dataset 130 corresponding to the row of the dataset 130. The BI application 110 detects the modification and saves the modified dataset 130 to the data store 120. Based on the hash function associated with the rows of the dataset 130, the BI application 110 generates another database index, for example a second database index, corresponding to the row including modified dataset 130. The second database index is stored in the data field 140 of the technical column corresponding to the row including the modified dataset 130. Based on the second index stored in the technical column, the row including the modified dataset can be determined.

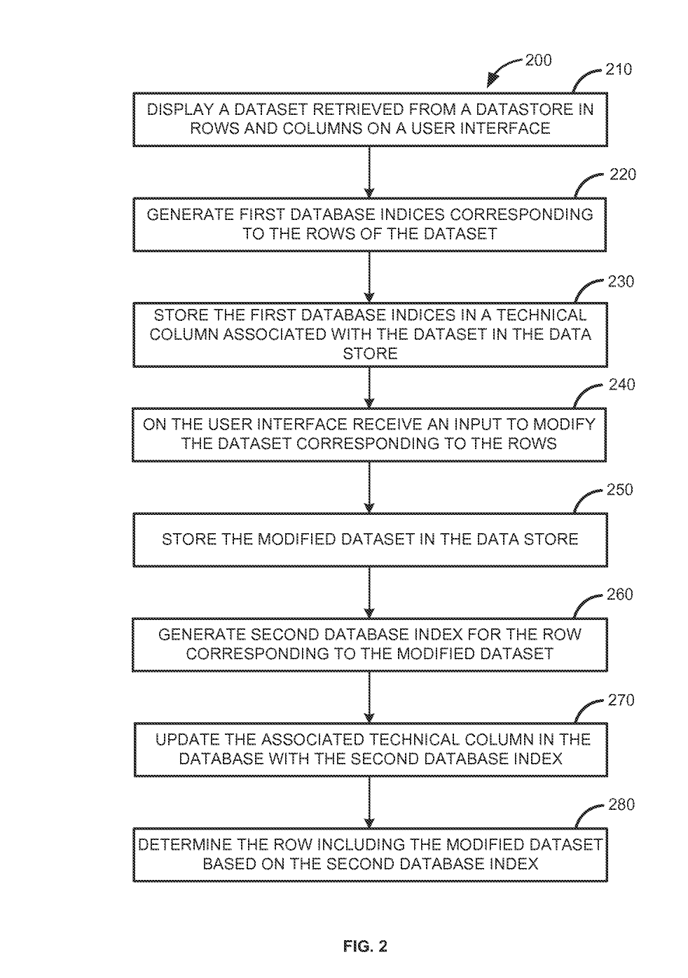

FIG. 2 is a flow diagram illustrating a method to determine a row with modified dataset, according to an embodiment. In an embodiment, a method 200 to determine a row with modified data includes displaying a dataset retrieved from a data store in rows and columns on a computer generated user interface, at process block 210. For the displayed dataset, a first database index corresponding to the rows, herein referred to a first database indices are generated, at the process block 220. The first indices are stored in a technical column in the data store, at process block 230. On the user interface, an input is received to modify the dataset corresponding to the row, herein referred to as modification of the dataset, at process block 240. The modified dataset is stored in the data store, at process block 250. A second database index for the row including the modified dataset is generated, at the process block 260. The corresponding technical column in the data store is updated with the second database index, at process block 270. The row including the modified dataset is determined based on the second database index stored in the technical column residing in the data store, at process block 280.

In another embodiment, a framework is generated to determine a row with transformed dataset. The framework includes a mechanism to retrieve a tabular data from a data store. The rows associated with the tabular data displayed on a computer generated user interface are determined. A first database index corresponding to the rows of the tabular data is generated and stored in a generated technical column residing in the data store. A modification on the dataset is received on the row of the tabular data. A second database index corresponding to the row including the modified data is generated and the corresponding technical column is updated with the second database index. Based on the second database index stored in the technical column, the identification framework is generated to identify the row with the modified data.

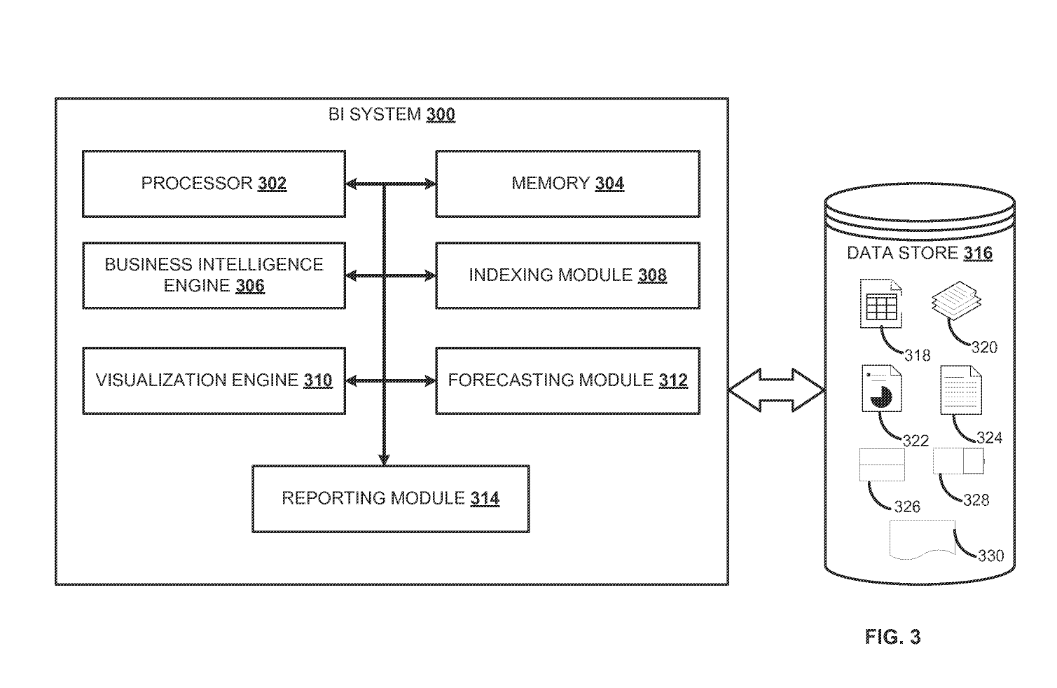

FIG. 3 is an exemplary illustration of an overview of a system to determine a row with modified dataset, according to an embodiment. In an embodiment, a BI system 300 is communicatively coupled to a data store 316. The data store 316 includes datasets 318, 320, 322, 324, 326, 328, and 330 stored in different file formats including tables, flat files, or the like. The dataset includes business information, for example data related to revenue, sales, operational data, or the like, associated with an enterprise. The dataset in the tables or the flat files is included in multiple cells arranged in rows and columns.

In an embodiment, the BI system 300 includes a processor 302 and a memory device 304 communicatively coupled to a data store 316 over a network (not shown). The BI system 300 includes business intelligence (BI) engine 306, a visualization engine 310, an indexing module 308, a forecasting module 312, and a reporting module 314 configured to work in conjunction with each other.

In an embodiment, the BI system 300 includes multiple interfaces that provide a diverse set of functionalities, as explained in the detailed description of FIG. 1. For instance, the BI system 300 includes a first user interface (UT) (not shown) to display the dataset 318, 320, 322, 324, 326, 328, and 330 residing in the data store 316A user may select the dataset via the first UI. The BI engine 306 of the system 300 retrieves the selected dataset from the data store 316 and displays the selected dataset on a second UI (not shown). The dataset including the data fields is displayed on the second UI in multiple cells arranged as rows and columns. The data fields represent attributes and associated values. For instance, the attributes are represented as the columns and the attribute values are represented as the rows. The attribute values may be identical. The columns may further be configured with additional functionalities, for example filtering dataset, sorting or reordering the dataset, or the like.

In an embodiment, the attribute values displayed on the second UI may be manipulated or modified in real time. The second UI of BI system 300 can receive the user input to modify the attribute values. The BI engine 306 of the system 300 identifies or determines the modified attribute value and saves the modified dataset in the data store 316. A process or a sequence of steps, herein referred as “transformation” is executed by the BI system 300 to identify the modified attribute value. The process of transformation includes determining the modified attribute value corresponding to the row; saving the modified attribute value representing the modified data in the data store 316; retrieving the dataset including modified attribute value from the data store 316; and refreshing or reloading the displayed data on the second UI to include the modified dataset. The row including the modified data may be dynamically repositioned on the second UI. For example, the second UI displays the dataset including the attribute values represented in ten rows. When the user modifies the attribute value corresponding to a third row, based on this modification, the BI system 300 executes the process of transformation. The second UI displaying the dataset includes the row with the modified attribute value and repositioned to represent an eighth row.

In an embodiment, the indexing module 308 implements a function, for example, a hash function to generate database indices corresponding to the rows of the dataset. The hash function is associated with the rows of the dataset and generates unique database indices, for example a first database index associated with each row of the dataset. The BI system generates a column, for example, a technical column associated with the dataset and stores the first database indices in the technical column.

In an embodiment, the hash function generates another database index, for example a second database index corresponding to the row including modified data. Each second database index is unique and provides an indication that the dataset or the attribute value in the corresponding row has been modified. The generated second database index is stored in the field of the technical column associated with the modified attribute value. For example, for the dataset displayed on the second UI, the hash function generates the first database index value, referenced as ‘13’ corresponding to the third row and stores the first database index value in the technical column in the data store. Upon modifying the attribute value corresponding to the third row, the hash function generates the second database index value, referenced as ‘131’ and updates the associated field in the technical column with the second database index value. Hence the field in the technical column corresponding to the third row will include the second database index value ‘131’, indicating that the dataset or the attribute value corresponding to the third row is modified. The row including the modified data is determined by identifying or determining the second database index stored in the technical column.

In an embodiment, consider an instance of the user modifying more than one attribute value corresponding to a row. For each instance of the modified attribute value corresponding to the row, a new index is regenerated and the corresponding field in the technical column is updated with the new index. For example, consider a dataset displayed on the second UI including five attributes represented by the columns C1, C2, C3, C4 and C5. These five attributes include values represented by the rows R1, R2, R3, R4, R5, R6, etc. The indexing module 308 of the BI system 300 generates unique first indices corresponding to the rows R1-R6 and stores the first indices in the technical column residing in the data store 316. On the displayed dataset, consider a user modifying an attribute value corresponding to the row R4 and the column C3. The indexing module 308 of the BI system 300 generates a unique second database index corresponding to the row R4; updates the corresponding field of the technical column in the data store 316 with the second database index value; and executes the process of transformation. Subsequently, consider the user modifying the attribute value corresponding to the row R4 and the column C2. The indexing module 308 of the BI system 300 generates a unique third database index corresponding to the row R4; updates the corresponding field in the technical column in the data store 316 with the third database index value; and executes the process of transformation.

In an embodiment, for each instance the modified data corresponding to the row, the indexing module 308 of the BI system 300 generates a unique database index; updates the corresponding field of the technical column in the data store 316; and executes the process of transformation. Based on the unique database index stored in the technical column, the row including modified data is determined. In an embodiment, modifying the dataset includes updating or modifying the attribute value of the dataset in the cells corresponding to the rows, deleting the attribute values of the dataset in the rows, deleting the rows, inserting new attribute values in the dataset, inserting one or more rows, or the like.

In an embodiment, the visualization engine 310 is configured to generate visualizations including graphical illustrations based on the processing and analysis of the dataset; and customizing the row including the modified dataset with a special icon or visual indicia to indicate that the corresponding row includes modified data. The visual indicia include, for example, highlighting the row including modified data; changing the font corresponding to the row including modified data, and the like. The forecasting module 312 is configured to generate forecasting information including graphical illustrations. The forecasting module 312 includes functions, algorithms, routines, procedures, statistical models, mathematical models, or the like, related business intelligence, artificial intelligence, etc. The forecasting module 312 generates forecasting reports based on the dataset associated with the enterprises. The reporting module 314 is configured to generate reports based on the analysis and processing of the dataset associated with the enterprise.

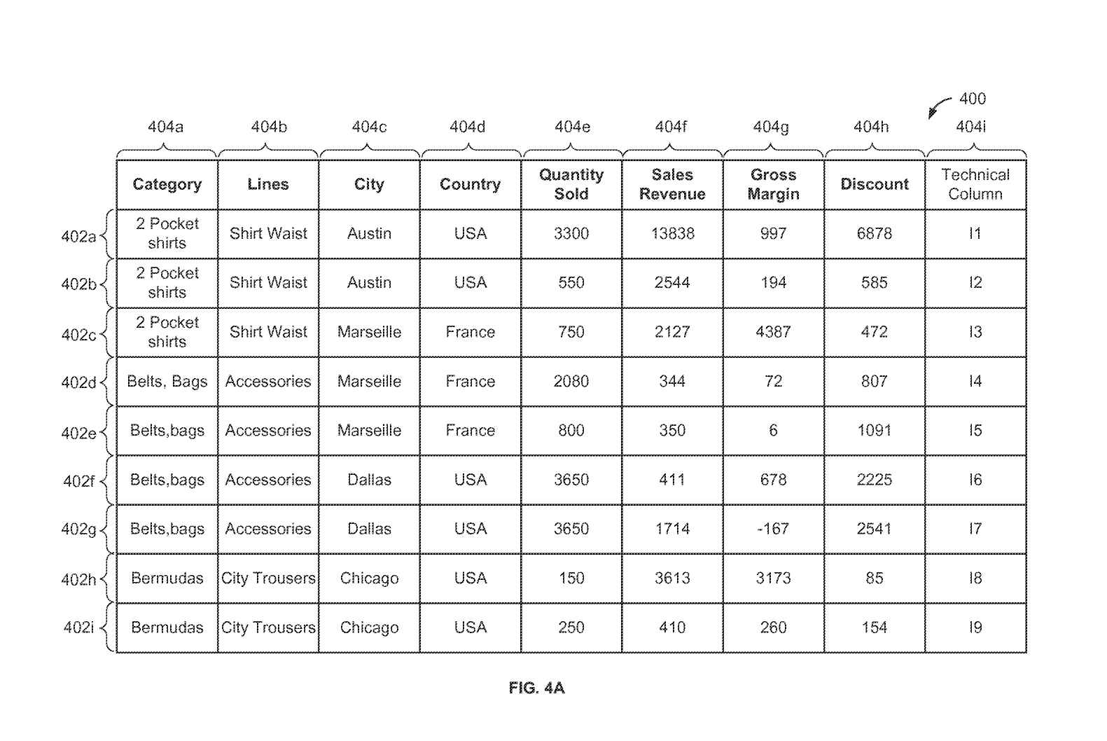

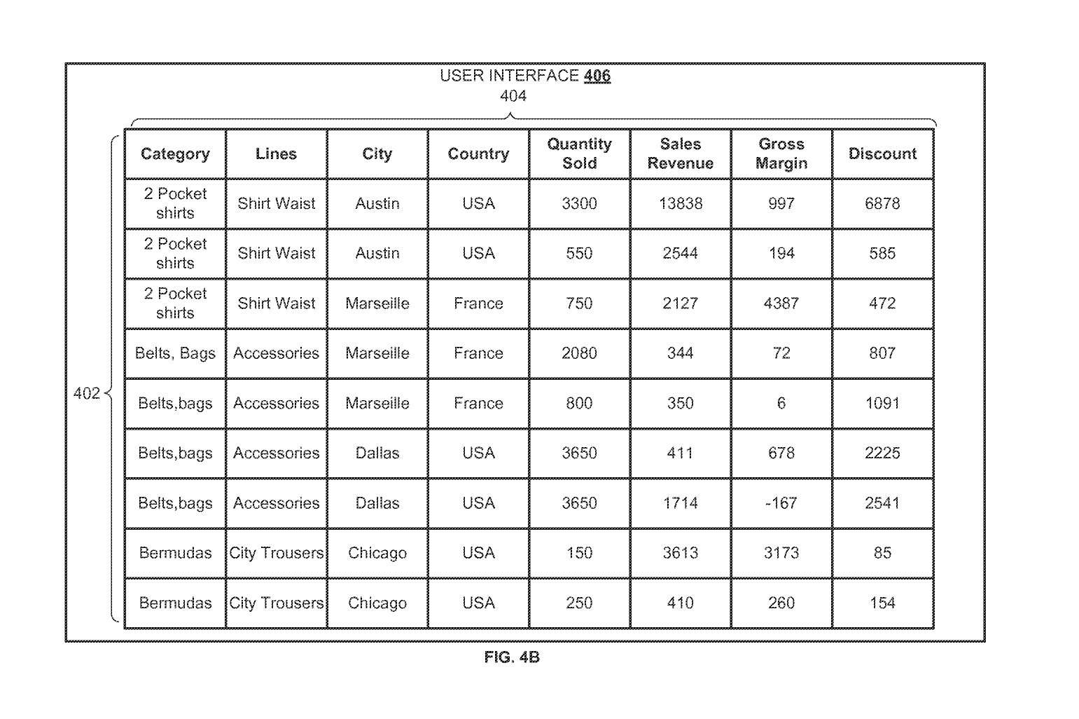

FIG. 4A is an exemplary illustration of dataset residing in a table in a data store, according to an embodiment. In an embodiment, dataset including attributes and associated values are stored in a table 400 in a data store 316. As exemplarily illustrated in FIG. 4A, the table 400 includes retail information associated with an enterprise. The retail information is represented in multiple cells arranged as rows 402a, 402b, 402c, 402d, 402e, 402f, 402g, 402h and 402i and columns 404a, 404b, 404c, 404d, 404e, 404f, 404g, 404h, and 404i. The dataset includes the attributes, represented by the columns 404a-404h. The attributes include, “Category”, “Lines”, “City”, “Country”, “Quantity Sold”, “Sales Revenue”, “Gross Margin”, and “Discount.” The associated attribute values are represented by the rows 402a-402i. For instance, the attribute values corresponding to the first row 402a include “2 Pocket Shirts”, “Shirt Waist”, “Austin”, “USA”, “3300”, “13838”, “997”, “6878”, etc. The indexing module 308 of the BI system 300 generates the first indices 404i corresponding to the rows 402a-402i based on a hash function associated with the rows 402a-402i. The first indices 404i are stored in the “Technical Column” associated with the dataset residing in the data store 316, as exemplarily illustrated in FIG. 4A.

FIG. 4B is an exemplary illustration of dataset displayed on a second user interface of the business intelligence system, according to an embodiment. In an embodiment, the dataset including the attributes 404 and the associated values 402 is retrieved by the BI system 300 from the data store 316 and displayed on the second UI 406. The dataset displayed on the second UI 406 includes the attributes 404 represented by the columns and the associated values 402 represented by the rows. The technical column including the first indices 404i is not displayed on the second UI 406.

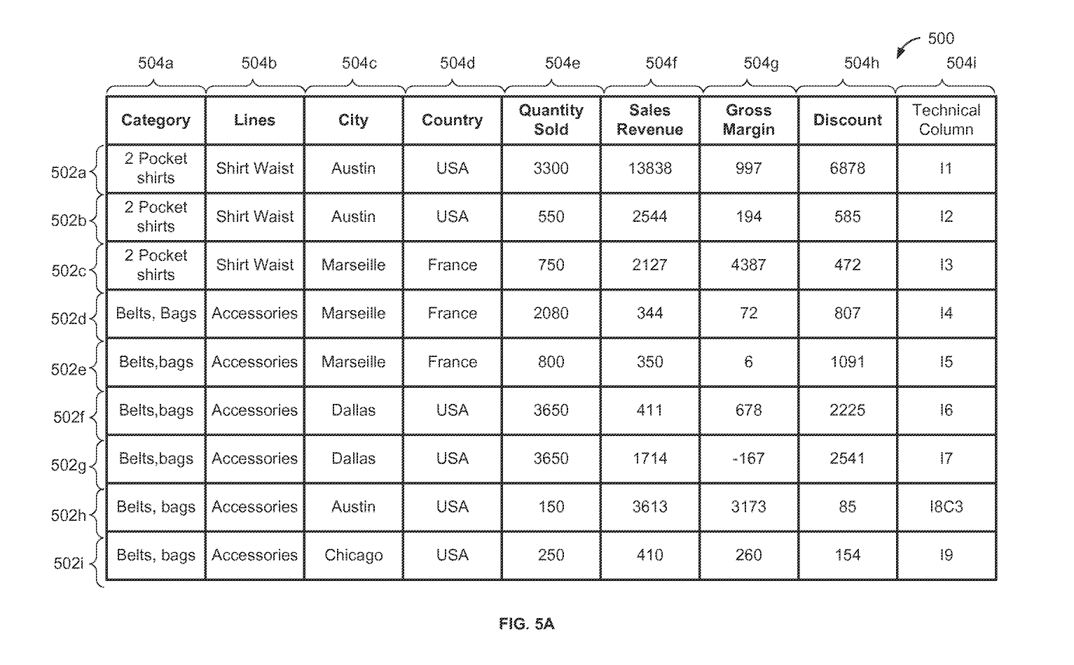

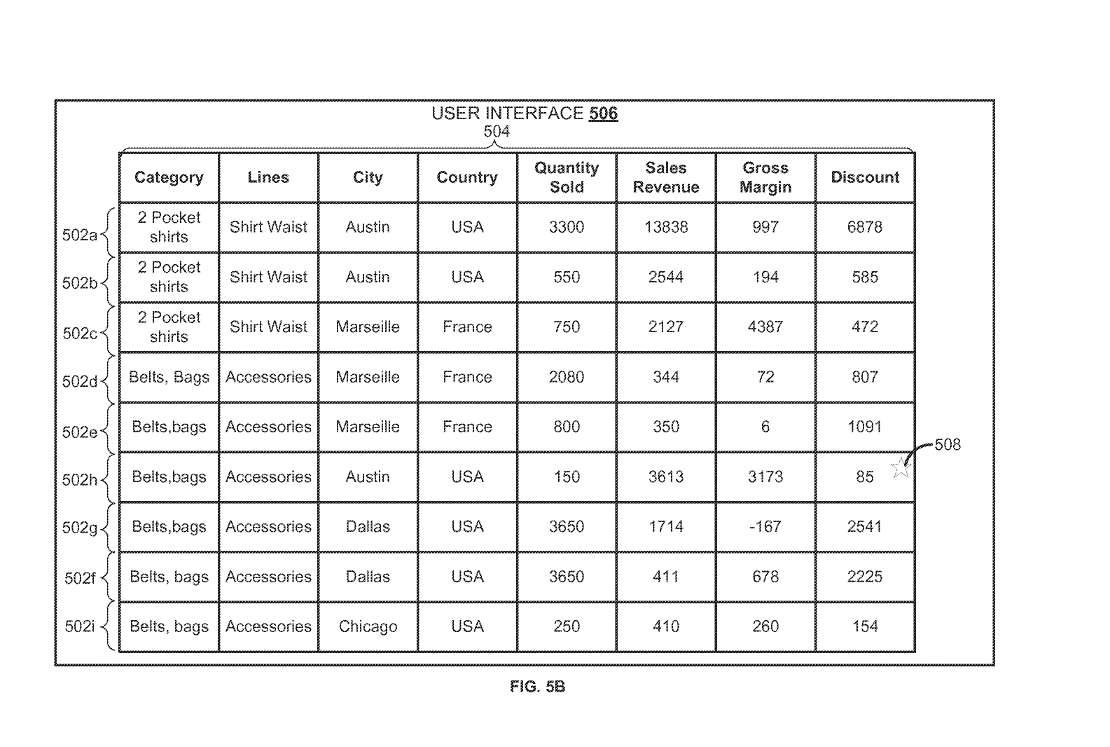

FIG. 5A is an exemplary illustration of dataset residing in a table in a data store, according to an embodiment. In an embodiment, the dataset displayed on the second UI 406 of the BI system 300 is operable to receive an input to modify the attribute values. Based on the modification, the BI system 300 executes the process of transformation. For example, as exemplarily illustrated in FIG. 5A, the attribute value corresponding to the eighth row 502h and third column 504c is modified; the attribute value is modified to include “Dallas” instead of the original value “Austin.” Based on this modification, the indexing module of the BI systems generates the second database index, referenced by ‘I8C3’ in the technical column 504i and updates the associated cell in the technical column 504i with the second database index. Based on this second database index, the row corresponding to the modified attribute value is identified.

FIG. 5B is an exemplary illustration of dataset displayed on a second user interface of the business intelligence system, according to an embodiment. In an embodiment, the dataset including the modified attribute value is retrieved by the BI system 300 from the data store 316 and displayed on the second 506. The technical column 504i including the second database index is not displayed on the second UI 506. The dataset displayed on the second UI 506 is operable to receive inputs to modify the attribute values. The BI system 300 determines the modified attribute value and saves the modified dataset in the data store 316. The BI system 300 then executes the process of transformation, as explained in detailed description of FIG. 1. The dataset including the modified attribute value is repositioned (indicated by 502h) and displayed on the second 506 as exemplarily illustrated in FIG. 5B. In another embodiment, the row 502h corresponding to the modified dataset is marked with a visual indicia or a special icon 508, as exemplarily illustrated in FIG. 5B. Based on the visual indication, the row with the modified data is determined. Other examples of visual indicia include special icon, highlight, font change, throbber, change of colour for area, change of colour for border, and the like.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a tangible computer readable storage medium. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

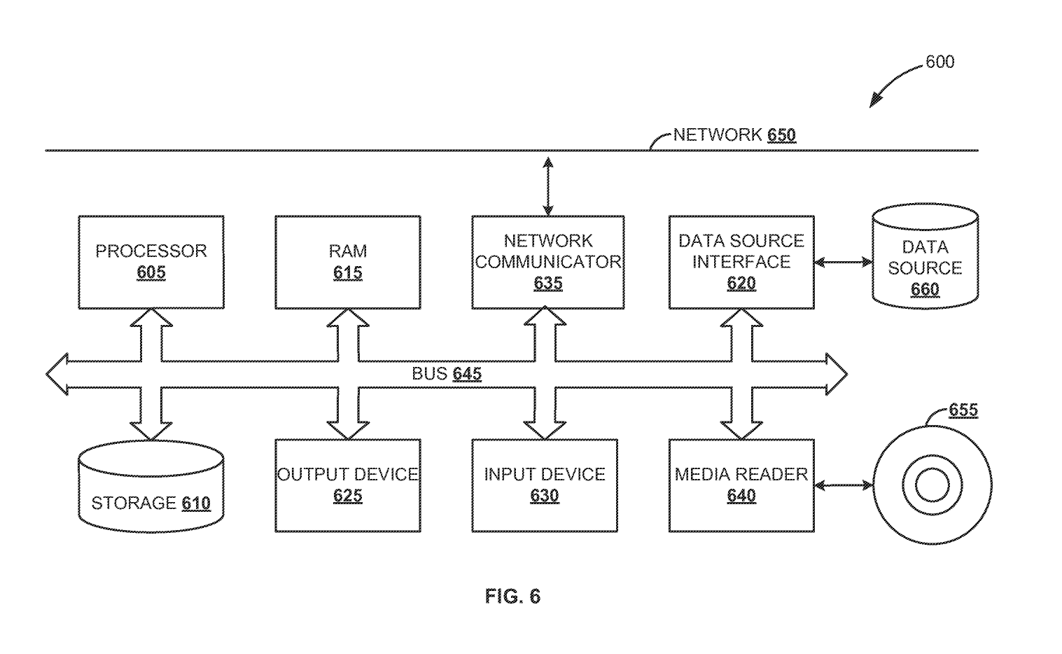

FIG. 6 is a block diagram of an exemplary computer system 600. The computer system 600 includes a processor 605 that executes software instructions or code stored on a computer readable storage medium 655 to perform the above-illustrated methods. The processor 605 can include a plurality of cores. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. According to some embodiments, such as some in-memory computing system embodiments, the RAM 615 can have sufficient storage capacity to store much of the data required for processing in the RAM 615 instead of in the storage 610. In some embodiments, all of the data required for processing may be stored in the RAM 615. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a mark-up language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc, in other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to determine a row with modified dataset, comprising:
displaying a dataset in a plurality of rows and a plurality of columns on a computer generated user interface by retrieving the dataset from a data store;
for the displayed dataset, a processor of the computer generating a first database index corresponding to the rows and storing the generated first database index in a technical column associated with the dataset in the data store;
on the user interface, receiving a modification on the dataset corresponding to the row and storing the modified dataset in the data store;
the processor of the computer generating a second database index for the row corresponding to the modified dataset, and updating the associated technical column in the data store with the second database index; and
based on the second database index, determining the row including the modified dataset.

2. The computer implemented method of claim 1, wherein: the first database index and the second database index are generated based on a hash function associated with the rows of the dataset.

3. The computer implemented method of claim 1 further comprising: upon storing the modified dataset in the data store, reloading the dataset on the user interface with the modified dataset.

4. The computer implemented method of claim 1, wherein: the first database index and the second database index are unique.

5. The computer implemented method of claim 1, wherein the modification of the dataset corresponding to the row is chosen from a group including: updating the dataset in the one or more cells, deleting the dataset in the one or more rows, deleting one or more rows, inserting data in the one or more rows, and inserting one or more rows.

6. The computer implemented method of claim 1, further comprising: customizing the row with the modified data by a visual indicia.

7. A computer implemented system to determine a row with modified dataset, comprising:
a processor operable to read and execute instructions stored in one or more memory elements;
a business intelligence engine to retrieve a dataset from a data store;
an output device to display the retrieved dataset in a plurality of rows and a plurality of columns on a computer generated user interface;
an indexing module to generate a first database index corresponding to the rows and store the generated first database index in a technical column associated with the dataset residing in the data store;
a user input device to modify the dataset corresponding to the row;
the business intelligence engine storing the modified dataset in the data store;
the indexing module to generate a second database index corresponding to the row with the modified dataset and update the technical column associated with the dataset residing in the data store; and
the one or more memory elements storing instructions related to:
determining the row including the modified dataset based on the second database index.

8. The computer implemented system of claim 7, further comprising: a visualization engine to generate visualizations including one or more graphical illustrations of the dataset.

9. The computer implemented system of claim 8, wherein the visualization engine is configured to customize the row including modified data with a visual indicia.

10. The computer implemented system of claim 7, further comprising: a forecasting module to generate forecasting information including one or more graphical illustrations of the dataset.

11. The computer implemented system of claim 7, further comprising: a reporting module to generate reports based on analysis of the dataset.

12. The computer implemented system of claim 7, wherein the indexing module generates the first database index and the second database index based on a hash function associated with the rows of the dataset.

13. The computer implemented system of claim 7, wherein the first database index and the second database index is unique.

14. The computer implemented system of claim 7, wherein the modification of the dataset corresponding to the row is chosen from a group including: updating the dataset in the one or more cells, deleting the dataset in the one or more rows, deleting one or more rows, inserting data in the one or more rows, and inserting one or more rows.

15. The computer implemented system of claim 7, wherein upon storing the modified dataset in the data store, reloading the dataset on the user interface including the modified dataset and displaying the modified dataset on the output device.

16. An article of manufacture including a non-transitory computer readable storage medium to tangibly store instructions, which when executed by a computer, cause the computer to:
determine one or more rows associated with a tabular data displayed on a computer generated user interface, by retrieving the tabular data from a data store;
generate a first database index corresponding to the rows of the tabular dataset and generate a corresponding technical column in the data store to store the first database index;
on the computer generated user interface, receive a modification on data corresponding to a row of the tabular dataset;
generate a second database index corresponding to the row with the mortification data and update the technical column with the second database index; and
generate an identification framework to identify the row with the modified data by determining the corresponding second database index from the technical column.

17. The article of manufacture of claim 16, wherein the first database index and the second database index is generated based on a hash function associated with the rows of the tabular dataset.

18. The article of manufacture of claim 16, wherein the first database index and the second database index are unique.

19. The article of manufacture of claim 16, further comprising: customizing a visual indicia for the row with the modified data.

20. The article of manufacture of claim 16 further comprising: upon receiving the modification on the tabular data, reloading the tabular data on the user interface with the transformed tabular data.
